(19) United States
(12) Patent Application Publication
(10) Pub. No.: US 2015/0009312 A1
(43) Pub. Date: Jan. 8, 2015

(54) REMOTE CAMERA ASSOCIATABLE WITH OBJECTS FOR WIRELESSLY TRANSMITTING VIDEO TO A HANDHELD DEVICE

(71) Applicants: Anthony Verna, Palm Desert, CA (US); Luis M. Ortiz, Albuquerque, NM (US)

(72) Inventors: Anthony Verna, Palm Desert, CA (US); Luis M. Ortiz, Albuquerque, NM (US)

(21) Appl. No.: 13/933,714

(22) Filed: Jul. 2, 2013

(51) Int. Cl. H04N 5/225

(52) U.S. Cl. CPC H04N 5/2257
USPC 348/77

(57) ABSTRACT

A holder capable of holding objects, such as a hair grooming tool, or being held by objects, including an integrated camera is provided that can communicate video wirelessly (e.g., via Bluetooth™) with a smartphone that includes a video application, wireless communications, and a display screen. The display screen can be a touchscreen. The hair-grooming tool can be a comb or brush. The smartphone can include a wireless data communications, e.g., Bluetooth™ communications. During use, a video application is activated and communication is established with the remote camera associated with the hair grooming tool/holder. Then, video images from the remote camera can be displayed on the display screen. if the smartphone includes a mirror app and an integrated front camera phone, a user can switch between the smartphone camera and the hair grooming tool's integrated camera by tapping the touchscreen or a button on the smartphone that is assigned to it.

### INVENTION PRIORITY

This patent application claims the benefit under 35 U.S.C. §119(e) of U.S. Provisional Application 61/667,560, entitled “Remote Camera Associatable with Objects for Wirelessly Transmitting Video to a Handheld Device,” which was filed on Jul. 3, 2012 and is incorporated herein by reference in its entirety.

### FIELD OF THE INVENTION

The present invention is related to wireless cameras of the size that can be integrated into small objects. The present invention is also related to wireless communication of video from a remote camera to portable hand held devices. More particularly, the present invention is related to a small camera and associated electronics incorporated into a housing and capable of real time, wireless video transmission wherein the housing can be associated with a hair grooming tool, such as a hair comb or hairbrush, or function as a holder of or be held by other objects for its use in video surveillance.

### BACKGROUND

When on the go, busy people are often concerned about the status of their grooming. Perhaps they are on a job interview, at a lunch or dinner meeting, at a social event, or an important client is arriving at a professional's office for a meeting, and facilities with mirrors are not readily available. In this case, women have been known to carry small mirrors (e.g., compact mirrors) and hair combs or brushes with them for their grooming needs. In fact, downloadable software applications are currently available that enable the front camera integrated into a smartphone to capture video images of a user and project the captured images on the display associated with the smartphone, similar to a compact mirror. These are referred to as “mirror apps” at online applications stores for iPhone™- and Android™-based portable devices.

Despite the availability of traditional compact mirrors, smartphone mirror apps, and combs and brushes, people concerned about theft grooming are limited in their ability to view the back of their heads or torsos when grooming themselves on the go. It would be useful for people to be able to view the back of their heads or torsos to view their hair or make sure that lint or stains are not visible on theft clothing.

The present invention provides a solution for this limitation of the past while leveraging state of the art technology. The present invention can also be adapted for use in remote surveillance in general and can be used in varied applications.

### SUMMARY

It is a feature of the present invention to provide a small wireless video camera capable of communicating wirelessly with a smartphone and integrated with a hair grooming tool (e.g., a hair comb or hairbrush) or a holder capable of securely holding a hair-grooming tool,

It is another feature of the present invention that the wireless camera communicates wireless with a handheld device such as a smartphone via a wireless data network or more directly using Bluetooth™ wireless technology.

It is yet another feature of the present invention that the wireless camera and associated electronics be integrated into the body of a holder, comb or hairbrush.

It is yet another features of he present invention that the wireless camera and associated electronics be integrated into the body of a holder/carrier that can accept and securely hold, or hold onto, objects such as hair grooming tools, wherein when used to hold a hair grooming tool such as a comb allows for the comb replacement should teeth break on the comb, and wherein use in general surveillance (with or without a comb) is enabled given the structure of the holder/carrier.

It is another feature of the present invention that a method is provided to allow a user to switch the display view from front camera view (camera integrated with smartphone) to remote camera view (camera associated with hair comb/brush).

It is a feature of the present invention that the method of switching between cameras can be incorporated into a mirror application that enables a tap of a touchscreen associated with the display to switch between cameras, or the touch of an assigned button on a smartphone can cause camera views to be switched.

It is another feature of the present invention that the method of switching between cameras can be incorporated into a mirror application and switching can be by pressing a button on the body containing remote camera electronics that is associated with the hair comb/brush.

It is another feature of the present invention that the holder/carrier includes a motion-sensing module for use in surveillance.

It is another feature of the present invention that the power source be rechargeable by at least one of USB, electromagnetic, and solar devices.

### BRIEF DESCRIPTION OF THE FIGURES

FIG. 1 is a diagram of a hair-grooming tool including an integrated camera and other supporting electronics;

FIGS. 2A-2B are an illustration of a holder capable of holding a hair grooming tool and other objects, the holder including an integrated camera and other supporting electronics;

FIG. 3B is an illustration of the end of the holder illustrated in FIG. 3A showing more clearly how a slot that can be adapted to accept objects or enable the holder to be held by objects;

FIG. 3A is an illustration of a system wherein a remote hair-grooming tool with an integrated camera is in wireless communication with a smartphone via a data network or by direct wireless communication;

FIG. 3B provides illustrations of two different screenshots on the display of a smartphone as a user toggles between the smartphone camera and a remote camera; and

FIG. 4 is a block diagram of a method of using a remote camera such as a camera integrated in a hair grooming tool and other electronics.

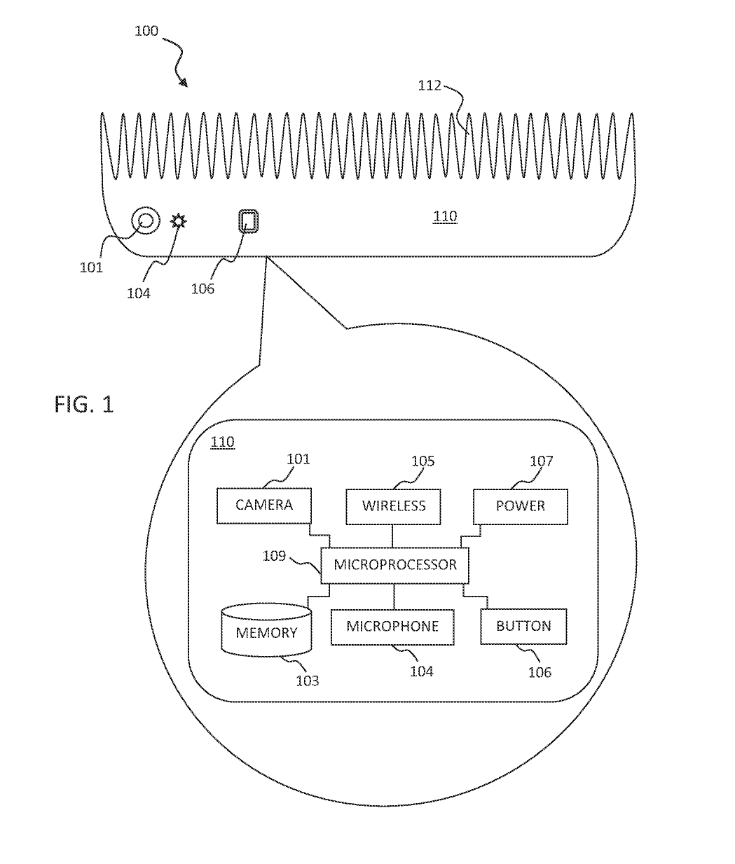

### DETAILED DESCRIPTION

The following patent applications are incorporated herein for their teaching in support of electronic aspects of the present invention, but are not deemed as prior art teachings of what are deemed to be patentable aspects of the present invention: 20070046887 to Howell et al, entitled “Eyewear supporting after-market electrical components”, and 20090209205 to Kramer et al, entitled “method and apparatus for transporting video signal over Bluetooth wireless interface.”

Very small cameras, such as pinhole cameras capable of capturing at least 30 frames per second, can be integrated into various objects, such as eyeglasses and pens, and their video can be processed (Le., compressed) for transmission (streaming as data) wirelessly. Video can be transmitted from a camera to a portable hand held devices such as a smartphone via a Bluetooth connection or over a wireless data network (e.g., 802.11). Mirror applications are available from application servers for download into smartphones so that smartphones having an integrated front camera can mimic a compact mirror.

Referring to FIG, 1, a grooming tool 100 is shown with a camera 101 can be integrated into its body 110. Also shown is a blown up block diagram of electronics associated with the grooming tool 100. The camera 101 will include wireless communication electronics 105 integrated into the body 110 that enable the camera 101 to communication wirelessly with a smartphone (not shown). Although Bluetooth™ is a current wireless standard that will enable communication of video between devices other wireless standard that might become known in the art can be used in this device 100. A power source 107, such a rechargeable battery or replaceable battery, will also be integrated into the body 110. It is preferred that the battery be rechargeable (e.g., via a USB connection to a computer or power plug, or electromagnetically), A memory 103, a microphone 104 and a record button 106 can also be included in the body 110 to store images/video for alternate applications, as will be further discussed below. A microprocessor 109 controls all functionality of the electronics in the grooming tool 100.

In a first embodiment, hair comb teeth or hair brush bristles 112 can be attached (or otherwise made part of) to the body 110 for grooming purposes. Because it is anticipated that teeth or bristles can become broken, missing or damaged; therefore, an alternative embodiment can provide the body 110 as a carrier (or holder) for replacement hair combs or hair brushes that can be securely held at their the body 110.

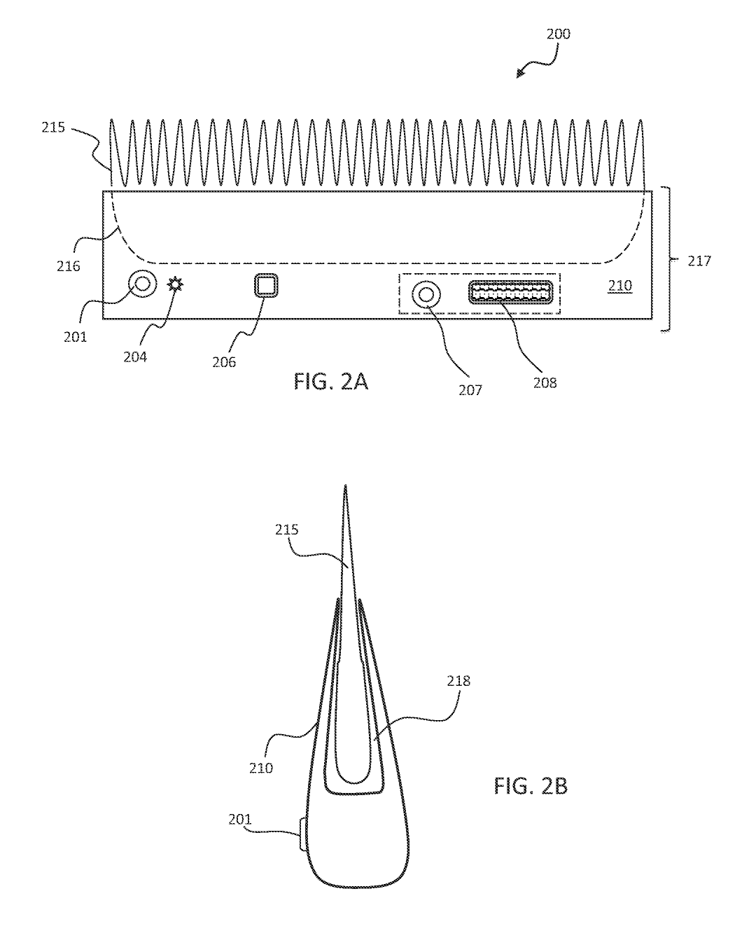

Referring to FIG. 2A, a body 210 of a device incorporating a camera 201 is shown as a carrier for, inter alia, a replacement hair comb 215. The hair comb 215 can be held firmly within the body 210 of the carrier by the hair comb's body 216. Referring to FIG. 2B, it can be appreciated given this teaching that the hair comb 215 (or other objects) can be slid into the body 210 at one of its ends 217, and/or can include a slot 218 that is expandable as the hair comb body 216 (or other object) is pushed into a slot 218. Hair combs can also be glued in place within the body 210 to assure a firm grip is accomplished.

An additional benefit of the alternate embodiment is that it can also be used for alternate applications as a secondary, remote camera. The camera 201 integrated in the body 210 can be used in association with the video recording capabilities of a smartphone where video is received and recorded, or can be stored in the memory 103 associated with the body 210 for later retrieval by the smartphone after a wireless data connection is established between them. Alternate applications include discrete (e.g., spy camera, portable private security surveillance) applications where video recording is desired in public areas, in premises or other environments. Such applications include office or home environment monitoring. Video and/or audio can be held in memory 103 until later retrieved by the smartphone (not shown), or can be streamed in real time to the smartphone.

Other optional electronics such as a motion sensor 108 and a solar cell 109 can be introduced into the carrier body 210 to support surveillance. For example, the slot and clip-like functionality of the body, as discussed with respect to FIG. 2B, can enable the body to be held onto a sun visor of an automobile. The sun visor could be oriented to capture images within or outside of the automobile. In order to assure battery life, the solar cell 109 can keep the power source 107 charged and enable motion sensing until video capture by the camera 201 is required. Captured video or images (and/or audio) can be downloaded into a smartphone wirelessly from the memory 103, as will be discussed below. The microprocessor controls motion detection, video capture, audio capture, power management, communications, and video transfer functionality of the system,

Referring to FIG, 3A, a system diagram 300 is shown wherein a hair grooming tool 310 (or carrier as discussed above) including a wireless camera 301 is communicating wirelessly with a smartphone 320, either directly 303 (e.g., Bluetooth™) or via a wireless data network 340 (e.g., 802.11, or RF broadcast). The wireless data network 340 can also allow the smartphone 320 to communicate with a remote server 350 in order to obtain applications such as an enhanced mirror application to enable the smartphone to carry out the present invention. Smartphone applications, such as a mirror app, can be obtained from various databases including Apple Corporations iPhone app store and Google's Android store.

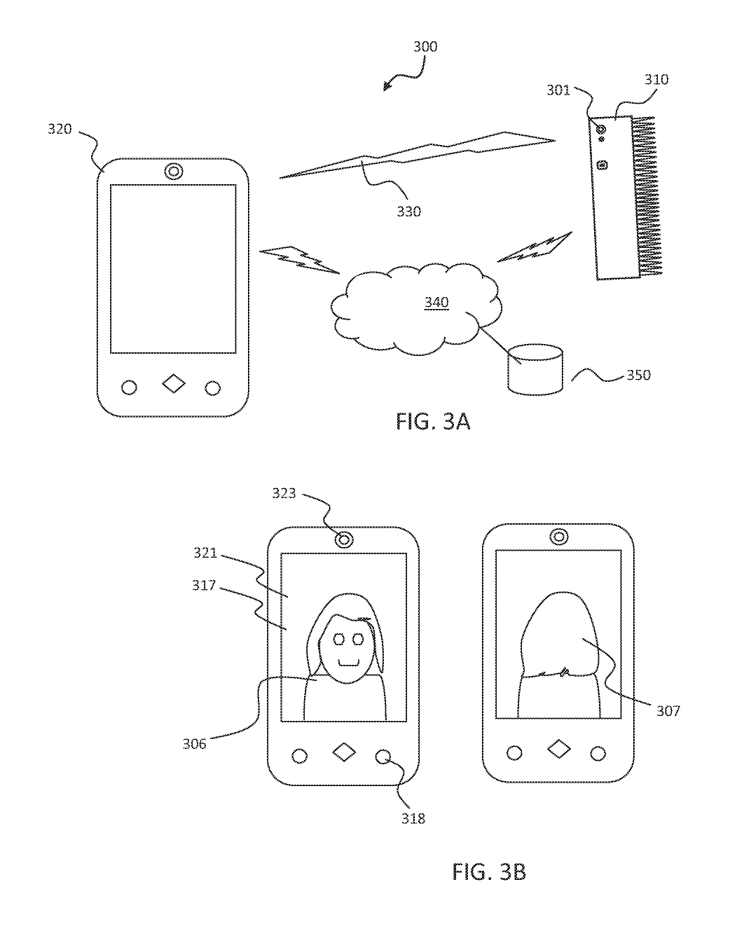

In FIG. 3B, two screenshots on the display 321 of the smartphone 320 are shown. The first screenshot 306 is an image captured by the smartphones integrated front camera 323 and processed for display by the smartphone, while the second screenshot 307 is an image captured by the wireless camera 301, compressed by electronics associated with the wireless camera and wirelessly transmitted (i.e., streamed) to the smartphone 320 for processing and viewing of the display 321. The smartphone will preferably have a touchscreen display so a user can select between the two screenshots by tapping the touchscreen 317 layered over the display 321. A button 318 on the smartphone can also be assigned to enable a user to switch between views.

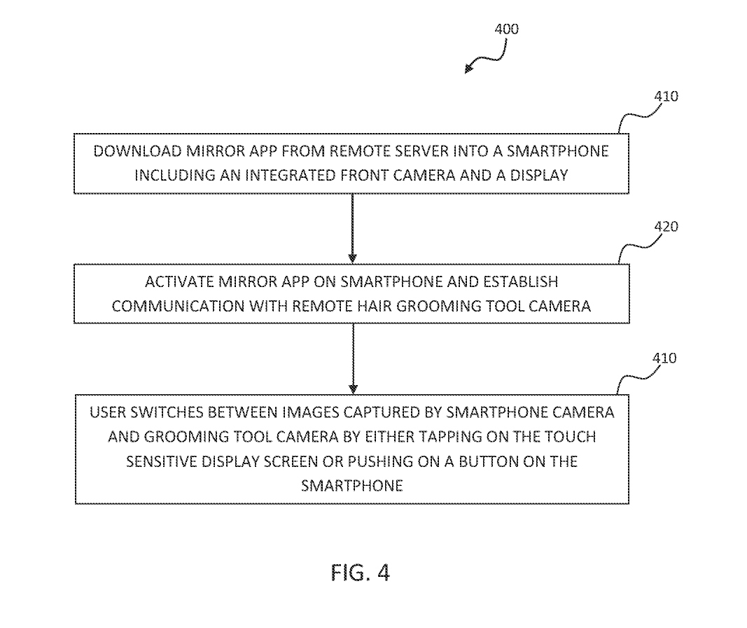

FIG. 4 illustrates steps 400 of a method of using the present invention. Referring to Block 410, a mirror app is downloaded from a remote server into a smartphone including an integrated front camera and a display. In Block 420, a mirror app activated on the smartphone and communication is established with a remote hair grooming tool camera. Then, a user of the smartphone and hair grooming tool switches between views on the smartphone display provided by the remote hair grooming tool camera and the integrated front camera in the smartphone by tapping on at least one of the smartphone display or an assigned button on the smartphone, as shown in Block 4.

1. A remote hair-grooming tool camera, comprising:
a hair brush or hair comb body including a camera, video processing electronics, wireless communication electronics and a power source therein; and
at least one of comb teeth or brush bristles integrated with the hair brush or hair comb body;
wherein video images captured by the camera are processed for wireless transmission by the video processing electronics and are transmitted wirelessly to a smartphone by the wireless communications electronics where activated the video images are viewed on a display integrated in the smartphone using a video application operating in the smartphone.

2. The remote hair grooming tool camera of claim 1, wherein the wireless communication electronics area Bluetooth™.

3. The remote hair grooming tool camera of claim 1, wherein the power source is a rechargeable battery.

4. The remote hair grooming tool camera of claim 3, wherein the rechargeable battery is recharged via USB.

5. (canceled)

6. A carrier including a slot with clip functionality to hold objects, comprising:
a body including a camera, video processing electronics, wireless communication electronics and a power source integrated therein; and
two walls extending from the body forming a slot, the two walls providing clip-like functionality and capable of holding objects fitting within the slot, said objects including at least one of a hair brush or hair comb;
wherein video images captured by the camera are processed for wireless transmission by the video processing electronics and are transmitted wirelessly to a smartphone by the wireless communications electronics where activated the video images are viewed on a display integrated in the smartphone using a video application operating in the smartphone.

7. The carrier including a slot with clip functionality to hold objects of claim 6, wherein the wireless communication electronics area Bluetooth™.

8. The carrier including a slot with clip functionality to hold objects of claim 6, wherein the power source is a rechargeable battery.

9. The carrier including a slot with clip functionality to hold objects of claim 8, wherein the rechargeable battery is recharged via USB.

10. (canceled)

11. The carrier including a slot with clip functionality to hold objects of claim 6, further comprising a motion sensor.

12. The carrier including a slot with clip functionality to hold objects of claim 8, further comprising a solar cell to charge the rechargeable battery.

13. A hair comb, comprising:
a body including a camera, video processing electronics, wireless communication electronics and a power source integrated therein; and
teeth integrated with and protruding from the body;
wherein video images captured by the camera are processed for wireless transmission by the video processing electronics and are transmitted wirelessly to a smartphone by the wireless communications electronics where activated the video images are viewed on a display integrated in the smartphone using a video application operating in the smartphone.

14. The hair comb of claim 11, wherein the wireless communication electronics area Bluetooth™.

15. The hair comb of claim 11, wherein the power source is a rechargeable battery.

16. The hair comb of claim 15, wherein the rechargeable battery is recharged via USB.

17. A method of using a smartphone to view images from a remote camera, comprising:
providing a smartphone including an embedded camera, a video application, a touch sensitive display screen and at least one button;
providing a remote camera including wireless data communications;
activated the video application and establishing communication with the remote camera; and
alternately viewing video images from the remote camera and the embedded camera on the display screen by touching at least one of the touch sensitive display screen.

18. A method of using a smartphone to view images from a remote camera in claim 17, wherein said video application is a mirror app downloaded from a remote server.

19. A method of using a smartphone to view images from a remote camera incorporated in an object holder including a body comprising two walls extending from the body forming a slot, the two walls providing clip-like functionality and capable of holding objects fitting within the slot, comprising:
providing a smartphone including a mirror app, an integrated front camera and a display screen;
providing a remote hair grooming tool camera;
activated the mirror app and establishing communication with the remote hair grooming tool camera; and
switching between views on the display provided by the remote hair grooming tool camera and the integrated front camera by at least one of tapping on the display screen or pushing an assigned button on the smartphone.
